(19) United States
(12) Patent Application Publication
(10) Pub. No.: US 2002/0171266 A1
(43) Pub. Date: Nov. 21, 2002

(54) Cover for a sliding roof

(76) Inventors: Hans Joachim Langhoff, Gifhorn (DE); Matthias Ludwig, Vechelde (DE); Anja Birnbaum, Gifhorn (DE)

Correspondence Address: CARLSON, GASKEY & OLDS, P.C., 400 WEST MAPLE ROAD, SUITE 350, BIRMINGHAM, MI, 48009, US

(21) Appl. No.: 10/151,426

(22) Filed: May 20, 2002

(30) Foreign Application Priority Data
May 21, 2001 (DE) 101 24 807.5

(51) Int. Cl. B60J 10/10

(52) U.S. Cl. 296/216.09

(57) ABSTRACT

A cover for a sliding roof comprises a cover plate, a frame that consists of a plastics material and is attached to the cover plate, and an edge gap seal that is applied to the frame. The frame is provided with a surrounding projection which is formed in one piece with the frame and is provided with at least a first nose, so that a first undercut is produced. The edge gap seal is provided with a clip that at least partially encompasses the projection.

### TECHNICAL FIELD

The invention relates to a cover for a sliding roof, comprising a cover plate, a frame that consists of a plastics material and is attached to the cover plate, and an edge gap seal that is applied to the frame.

### BACKGROUND OF THE INVENTION

Such a cover is known from DE 199 23 725 C1. For attachment of the edge gap seal, there is used a groove having a T-shaped cross-section which is milled into the edge of the frame after its production.

It is a disadvantage of the known cover that the edge gap seal can not be attached to the frame with the desired accuracy. With the known cover, the inevitable tolerances at the production of the frame are additionally superimposed by a tolerance during milling of the groove. It can therefore not be ensured that the edge gap seal inserted into the groove terminates flush with the surface of the cover and of the frame, as is desired because of visual reasons. It is a further disadvantage of the known cover that the expenditure in terms of manufacturing is comparably high.

The object of the invention therefore is to provide a cover of the type initially mentioned in which the edge gap seal is able to be applied to the frame within narrow tolerances, so that it terminates flush with the latter, and which can be produced at a favorable cost.

### BRIEF SUMMARY OF THE INVENTION

According to the invention, a cover for a sliding roof comprises a cover plate, a frame that consists of a plastics material and is attached to the cover plate, and an edge gap seal that is applied to the frame. The frame is provided with a surrounding projection which is formed in one piece with the frame and is provided with at least a first nose, so that a first undercut is produced. The edge gap seal is provided with a clip that at least partially encompasses the projection. In this way, the undercut required for applying the edge gap seal is formed immediately with molding or foaming the frame. Thus, the position of the undercut only depends from the tolerances that are present during the manufacture of the foaming mold for the frame. Once the foaming mold has been produced, the position of the undercut in each of the covers produced by means of this foaming mold is not afflicted with tolerances any more. If the parting plane of the foaming mold is provided at an appropriate place, the parts can be removed from the mold without complicated sliders having to be used. This allows a cost-effective production.

It is preferably provided for that the edge gap seal is a two-component piece made of plastics, the first one of the two components with a higher hardness forming the clip and the second one with a lower hardness forming a sealing section. It is in this way that the desired high holding force of the edge gap seal on the projection of the frame can be achieved together with a high resilience in those portions that have contact with associated sealing surfaces.

Advantageous designs of the invention will be apparent from the sub-claims.

### BRIEF DESCRIPTION OF THE DRAWINGS

FIG. 1 shows schematically a vehicle roof comprising a cover according to the invention; and

FIG. 2 shows a section taken along plane II-II of FIG. 1 through the edge of a cover according to the invention.

### DETAILED DESCRIPTION OF THE PREFERRED EMBODIMENT

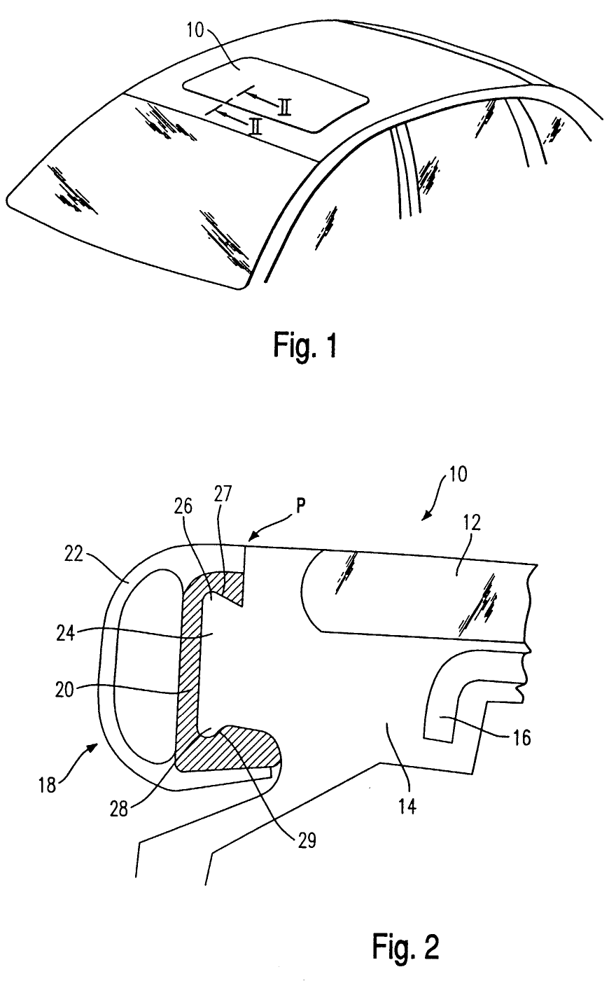

In FIG. 1 there can be seen a schematically shown vehicle roof which is provided with a cover 10 for a sliding roof. The cover can be pushed from the position shown in FIG. 1 towards the rear, in order to expose a roof opening. The cover 10 consists substantially of a cover plate 12 (see FIG. 2) and a frame 14. The cover plate 12 can be made of glass, a suitable plastics material having sufficient hardness or also of a metal sheet. The frame 14 consists of plastics and is permanently connected with the cover plate 12; to this end, the cover plate 12 usually is embedded in the plastics material of the frame by injection molding or foaming. In so doing, inlay pieces 16 may be inserted in the frame 14, in order to enhance the stability of the frame. This, however, is not of importance for the invention.

The frame 14 is provided with an edge gap seal 18 consisting of a clip 20 and a sealing section 22. The edge gap seal 18 consists of plastics, and the clip 20 and the sealing section 22 constitute components of differing hardness. The clip 20 is made of a material having a higher hardness, so that it has the desired strength, whereas the sealing section 22 is made of a material having a lower harness, so that the sealing section has the desired elasticity.

For attaching the edge gap seal 18 to the frame 14, the latter is provided with a surrounding projection 24 which, in the cross-sectional view of FIG. 2, has a first nose 26 and a second nose 28 at its upper and lower edges, respectively. The first nose 26 has a straight rear face 27 extending obliquely towards the frame 14, whereas the second nose 28 has a rear face 29 that extends towards the frame in a curved manner.

The two noses 26, 28 on the projection 24 each constitute an undercut, so that the clip 20 of the edge gap seal 18 can be slipped on the projection 24 and snaps in place there. Thereby, the edge gap seal is firmly attached to the frame 14.

Since the position of the projection 20 relative to the frame and in particular to the upper side thereof is precisely defined by the foaming mold used for producing the frame, the edge gap seal 18 can be attached to the frame 14 with very high accuracy. In this way there can be achieved a flush transition without any steps between the edge gap seal 18 and the frame 14 on the upper side (the place designated by arrow P), such transition being desirable for visual reasons and with respect to low contamination.

1. A cover for a sliding roof, said cover comprising a cover plate, a frame that consists of a plastics material and is attached to said cover plate, and an edge gap seal that is applied to said frame,
said frame being provided with a surrounding projection which is formed in one piece with said frame and is provided with at least a first nose, so that a first undercut is produced, and said edge gap seal being provided with a clip that at least partially encompasses said projection.

2. The cover according to claim 1, wherein said first nose has a rear face extending obliquely towards said frame.

3. The cover according to claim 1, wherein said projection has a second nose, so that a second undercut is produced.

4. The cover according to claim 3, wherein said second nose has a rear face that extends towards said frame in a curved manner.

5. The cover according to claim 1, wherein said edge gap seal is a two-component piece made of plastics, the first one of said two components with a higher hardness forming said clip and the second one with a lower hardness forming a sealing section.
